(19) United States
(12) Patent Application Publication
(10) Pub. No.: US 2022/0259882 A1
(43) Pub. Date: Aug. 18, 2022

(54) MODULAR TUBE AND METHOD OF MANUFACTURING

(71) Applicants: BALFOUR BEATTY PLC, London (GB); INNOVATION TO INDUSTRY LIMITED, Nottingham (GB)

(72) Inventors: David CHAMBERS, Nottingham (GB); Douglas GRAY, Derbyshire (GB)

(21) Appl. No.: 17/618,874

(22) PCT Filed: Jun. 11, 2020
(86) PCT No.: PCT/GB2020/051413

§ 371 Date: Dec. 13, 2021

(30) Foreign Application Priority Data
Jun. 14, 2019 (GB) 1908542.2

(51) Int. Cl. E04H 12/02; F16L 9/22; F16L 9/16; F16L 9/18; E04C 3/36

(52) U.S. Cl. CPC E04H 12/02; F16L 9/22; E04H 12/342; F16L 9/18; E04C 3/36; F16L 9/16

(57) ABSTRACT

The invention provides a tube for use as part of a structural support pole, and a method for manufacturing a tube, comprising a plurality of tube perimeter sections, wherein each tube perimeter section of the first plurality of tube perimeter sections is formed by pultrusion, each tube perimeter section of the first plurality of tube perimeter sections having the same pultrusion cross-sectional shape, and wherein each tube perimeter section comprises: an outer surface; an inner surface; a side surface; and a cavity between the inner surface and the outer surface, wherein the cavity extends through the tube perimeter section. The side surface is adapted to be fastened to an adjacent side surface of an adjacent tube perimeter section, thereby to form an annular arrangement of tube perimeter sections. The tube further comprises a first filament, wherein the first filament is wound about the outer surfaces of the first plurality of tube perimeter sections arranged in an annular arrangement.

### FIELD OF THE INVENTION

The invention relates to the field of constructing tubular structures, and more specifically to the field of constructing modular tubular structures.

### BACKGROUND OF THE INVENTION

Tubular structures, such as utility poles, are now being designed to achieve ever increasing design loads. As a result, utility poles are becoming prohibitively large to produce as a single monolithic circular section using traditional manufacturing techniques, such as filament winding or pultrusion.

For filament winding, the mandrels become incredibly heavy and the motors required to overcome the winding torque are excessive. For pultrusion, the puller force becomes very high, resulting in very expensive equipment and the creel racking for the large number of glass fibre bobbins occupies considerable space behind each machine, which increases operational costs.

A further significant barrier to traditional composite tubular structures being made larger is that they rely on a single skin to form the walls and, particularly at large diameters, the ratio of wall thickness to pole diameter results in local wall instability and premature buckling.

There is therefore a need for an alternative means of producing tubular structures without the limitations outlined above.

### SUMMARY OF THE INVENTION

The invention is defined by the claims.

According to examples in accordance with an aspect of the invention, there is provided a tube for use as a part of a structural support pole comprising:

a first plurality of tube perimeter sections, wherein each tube perimeter section of the first plurality of tube perimeter sections is formed by pultrusion, each tube perimeter section of the first plurality of tube perimeter sections having the same pultrusion cross-sectional shape, and wherein each tube perimeter section comprises:
an outer surface;
an inner surface;
a side surface, wherein the side surface is adapted to be fastened to an adjacent side surface of an adjacent tube perimeter section, thereby to form an annular arrangement of tube perimeter sections; and
a cavity between the inner surface and the outer surface, wherein the cavity extends through the tube perimeter section; and

a first filament, wherein the first filament is wound about the outer surfaces of the first plurality of tube perimeter sections arranged in an annular arrangement.

The invention provides for a tube for use as part of a structural pole that may be constructed from a plurality of simply pultruded sections, which are then combined to form the full tube.

By forming the tube from a number of tube perimeter sections, the construction process is simplified over typical construction methods using a filament winding process that can be complex, particularly when the size of the tube increases.

In addition, by providing a filament wind over the first plurality of tube perimeter sections, a high strength outer layer may be incorporated into the tube without the need for a separate metal winding mandrel which is used in traditional filament winding processes. The filament may be a resin infused glass fibre filament.

This construction may also simplify transportation of the parts to the installation point.

In an embodiment, the side surface comprises.

a projecting portion; and

a recessed portion, wherein the recessed portion is adapted to receive the projecting portion of an adjacent side surface. The tessellation of the side surfaces may help to increase the strength of the adhesion between the side surfaces.

In an embodiment, the tube further comprises one or more transition tube perimeter sections, wherein the one or more transition tube perimeter sections are adapted to be located between the side surfaces of adjacent tube perimeter sections, and wherein each transition tube perimeter section comprises:

a first surface adapted to be fastened to the side surface of a first tube perimeter section; and

a second surface adapted to be fastened to the side surface of a second tube perimeter section, thereby fastening the side surface of the first tube perimeter section to the side surface of the second tube perimeter section by way of the one or more transition tube perimeter sections.

In this way, the shape and composition of the tube may be adjusted according to the application of the structural pole.

In an embodiment, the tube comprises a filler, and wherein the cavity of each perimeter tube section is adapted to receive the filler, the filler comprising one or more of:

a cement; and

a polymer-based foam; and

a polymer-based rigid filler.

In this way, the strength, and in some cases stiffness, of the tube may be increased. The filler may extend beyond an end of the tube perimeter section and may extend into the cavity of another tube perimeter section.

In an embodiment, each tube perimeter section comprises a percentage of uni-directional fibres greater than or equal to 30%, for example, greater than or equal to 40%, for example, greater than or equal to 50%.

In this way, the strength of the tube perimeter sections may be improved.

In an embodiment, the first filament is wound about the first plurality of tube perimeter sections at a wind angle, wherein the wind angle is defined between a longitudinal axis, which is defined as the central axis of the annular arrangement of tube perimeter sections, and a filament elongate axis, and wherein the wind angle is between 30° and 90°.

In an embodiment, the cross-section of the tube, perpendicular to a tube elongate axis, is one or more of:

a circular shape;

an elliptical shape;

a square shape,

a rectangular shape; and

a polygonal shape.

In an embodiment, the tube further comprises:

a second plurality of tube perimeter sections, wherein each tube perimeter section of the second plurality of tube perimeter sections is formed by pultrusion, each tube perimeter section of the second plurality of tube perimeter sections having the same pultrusion cross-sectional shape, and wherein each tube perimeter section comprises:
an outer surface;
an inner surface;
a side surface, wherein the side surface is adapted to be fastened to an adjacent side surface of an adjacent tube perimeter section, thereby to form an annular arrangement of tube perimeter sections; and
a cavity between the inner surface and the outer surface, wherein the cavity extends through the tube perimeter section;

a second filament, wherein the second filament is wound about the outer surfaces of the second plurality of tube perimeter sections arranged in an annular arrangement; and

wherein the second plurality of tube perimeter sections is adapted to be stacked on the first plurality of tube perimeter sections.

In this way, the tube structure may be extended to any desired length without requiring the tube perimeter sections of each level to be made prohibitively large, thereby simplifying the construction of the structural pole.

In an embodiment, the tube further comprises an internal connector adapted to be received by a cavity of a tube perimeter section, and wherein, when the second plurality of tube perimeter sections is stacked on the first plurality of tube perimeter sections, the internal connector is adapted to extend from a cavity of a tube perimeter section of the first plurality of tube perimeter sections to a cavity of a tube perimeter section of the second plurality of tube perimeter sections.

In this way, the first and second plurality of tube perimeter sections may be aligned in a simple and efficient manner when being stacked, thereby simplifying the construction of the structural pole. In addition, the internal connector may serve to reinforce the connection between the stacked pluralities of tube perimeter sections, thereby improving the strength of the structural pole.

In an embodiment, the tube comprises a plurality of reinforcement rods and wherein the side surface of each tube perimeter section comprises a slot adapted to receive a reinforcement rod. In this way, the strength of the tube may be further increased. The reinforcement rods may extend beyond an end of the tube perimeter section, thereby increasing the strength of the tube across multiple stacked levels of tube perimeter sections.

According to examples in accordance with an aspect of the invention, there is provided a method for manufacturing a tube for use as a part of a structural support pole, the method comprising:

pultruding a first plurality of tube perimeter sections, the first plurality of tube perimeter sections having the same pultrusion cross-sectional shape, wherein each tube perimeter section of the first plurality of tube perimeter sections comprises:
an outer surface;
an inner surface;
a side surface, wherein the side surface is adapted to be fastened to an adjacent side surface of an adjacent tube perimeter section; and
a cavity between the inner surface and the outer surface, wherein the cavity extends through the tube perimeter section;

fastening the first plurality of tube perimeter sections to each other by way of the side surfaces, thereby forming a first cross-section of the tube; and

winding a first filament about the outer surfaces of the first plurality of tube perimeter sections.

In an embodiment, the side surface of the perimeter sections comprises:
a projecting portion; and
a recessed portion, wherein the recessed portion is adapted to receive the projecting portion of an adjacent side surface;
and wherein the method further comprises aligning the extending portion of a tube perimeter portion with the recessed portion of an adjacent tube perimeter portion; or

the tube further comprises one or more transition tube perimeter sections adapted to be located between the side surfaces of adjacent tube perimeter sections, and wherein each transition tube perimeter sections comprises:
a first surface adapted to be fastened to the side surface of a first tube perimeter section; and
a second surface adapted to be fastened to the side surface of a second tube perimeter section;
and wherein the method further comprises fastening the first surface to the side surface of a first tube perimeter section and fastening the second surface to the side surface of a second perimeter section, thereby fastening the side surface of the first tube perimeter section to the side surface of the second tube perimeter section by way of the one or more transition tube perimeter sections.

In an embodiment, the side surface of each tube perimeter section comprises a slot adapted to receive a reinforcement rod, and wherein the method further comprises inserting the reinforcement rod into the slot.

In an embodiment, the method further comprises filing the cavity.

In an embodiment, the method further comprises:

pultruding a second plurality of tube perimeter sections, the second plurality of tube perimeter sections having the same pultrusion cross-sectional shape, wherein each tube perimeter section of the second plurality of tube perimeter sections comprises:
an outer surface,
an inner surface;
a side surface, wherein the side surface is adapted to be fastened to an adjacent side surface of an adjacent tube perimeter section; and
a cavity between the inner surface and the outer surface, wherein the cavity extends through the tube perimeter section;

fastening the second plurality of tube perimeter sections to each other by way of the side surfaces, thereby forming a second cross-section of the tube;

winding a second filament about the outer surfaces of the first plurality of tube perimeter sections; and

stacking the second plurality of tube perimeter sections on the first plurality of tube perimeter sections.

In a further embodiment, the method further comprises providing an internal connector to the cavity of each of the tube perimeter sections, wherein the internal connector is adapted to extend from a cavity of a tube perimeter section of the first plurality of tube perimeter sections to a cavity of a tube perimeter section of the second plurality of tube perimeter sections when the second plurality of tube perimeter sections is stacked on the first plurality of tube perimeter sections.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows an exploded view of a tube according to an aspect of the invention;

FIG. 2 shows an exploded view of a tube according to an embodiment of the invention;

FIG. 3 shows a cross-section of a tube according to an embodiment of the invention;

FIG. 4 shows a plurality of possible tube cross-sections;

FIG. 5 shows a cross-section of a tube perimeter section according to an embodiment of the invention;

FIG. 6 shows an exploded view of a tube according to an embodiment of the invention,

FIG. 7 shows a perspective view of a tube according to an embodiment of the invention;

FIG. 8 shows an exploded view of a tube according to an embodiment of the invention; and

FIG. 9 show a method according to an aspect of the invention.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a tube for use as part of a structural support pole, and a method for manufacturing a tube, comprising a plurality of tube perimeter sections, wherein each tube perimeter section of the first plurality of tube perimeter sections is formed by pultrusion, each tube perimeter section of the first plurality of tube perimeter sections having the same pultrusion cross-sectional shape, and wherein each tube perimeter section comprises: an outer surface; an inner surface; a side surface; and a cavity between the inner surface and the outer surface, wherein the cavity extends through the tube perimeter section. The side surface is adapted to be fastened to an adjacent side surface of an adjacent tube perimeter section, thereby to form an annular arrangement of tube perimeter sections. The tube further comprises a first filament, wherein the first filament is wound about the outer surfaces of the first plurality of tube perimeter sections arranged in an annular arrangement.

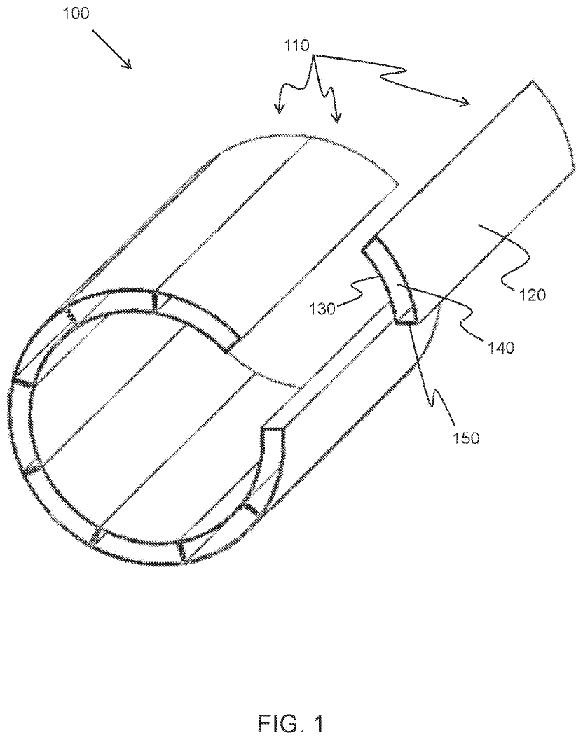

FIG. 1 shows an exploded view of a tube 100 according to an aspect of the invention.

The tube 100 includes a plurality of tube perimeter sections 110 and each tube perimeter section comprises: an outer surface 120; an inner surface 130; a cavity disposed between the outer surface and the inner surface 140; and a side surface 150. The example shown in FIG. 1 includes a cavity 140; however, the tube perimeter sections may be constructed without the cavity. In other words, the tube perimeter sections may be constructed as solid sections, or may include a cavity. The cavity may pass through the entire tube perimeter section. Alternatively, the cavity may extend through a portion of the tube perimeter section. A tube perimeter section may include multiple cavities.

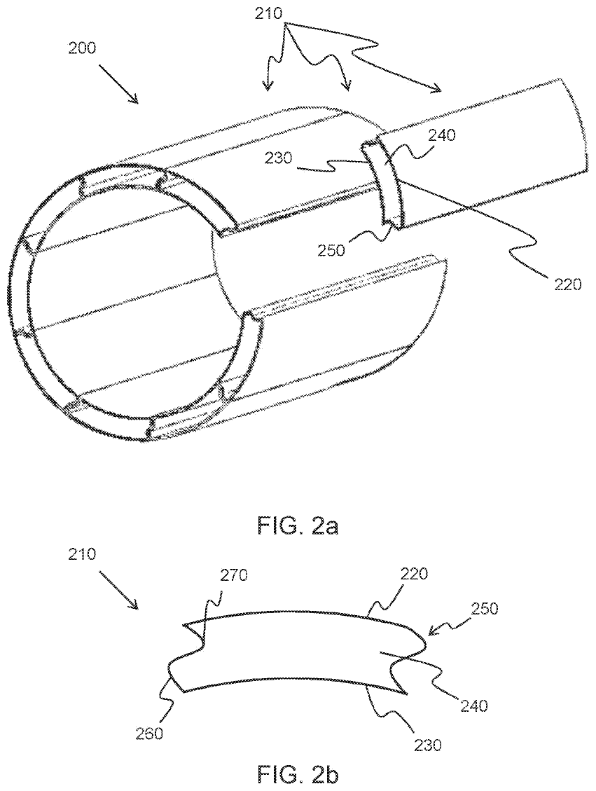

The side surface 150 is adapted to be fastened to an adjacent side surface of an adjacent tube perimeter section, thereby forming an annular arrangement of tube perimeter sections as shown in FIG. 1. The side surfaces of adjacent tube perimeter sections may be fastened to each other directly or indirectly, examples of which are provided further below with reference to FIGS. 2a, 2b, 3 and 4.

Both the manufacturing and design issues associated with constructing large tubular structures may be overcome by creating a tube 100 that is formed from multiple segments, such as the plurality of tube perimeter sections 110 that interlock together around the perimeter of the tube as shown in FIG. 1.

As the tube perimeter sections are hollow in profile, when they are arranged adjacent to each other to form the finished tube structure, a bi-wall structure is formed with radial ribs, in the form of the side surfaces 150, connecting the inner 130 and outer 120 walls.

In an example, the tube has a 1 m inside diameter, from inner surface to inner surface, and a 1.2 m outside diameter, from outer surface to outer surface. Thus, the cavity thickness may be 90 mm, accounting for a nominal wall thickness of 5 mm.

Numerous combinations of resins and reinforcing materials may be used to construct the tube perimeter sections. For example, the resins may include: polyesters, vinyl esters, epoxy and polyurethane resin and the like. The reinforcement materials may include glass fibre, carbon fibre, aramid or hemp fibre and the like. The combination of reinforcement and resin may be varied depending on the application of the tube.

Each tube perimeter section may comprises a percentage of uni-directional fibres greater than or equal to 30%, for example, greater than or equal to 40%, for example, greater than or equal to 50%. The greater the percentage of uni-directional fibres, the more robust each of the tube perimeter sections is.

In other words, the invention provides for a tube that may be constructed from a plurality of sections, each of which may be constructed by way of a simple pultrusion method and then combined to form the full tube.

Further, in the case that the tube perimeter sections include a cavity, the bi-wall structure of the tube may increase the strength and stability of the overall tube.

The modular nature of the tube perimeter sections 110 may provide for a means to form a complete annulus of any desired diameter by adjusting the curvature of the outer 120 and inner surfaces 130. Each segment may be sized appropriately to be manufactured using a standard pultrusion machine, thereby minimizing cost (in terms of tooling and/or machine capacity and setup) and maximizing supplier options. The sections may then be shipped in a compact manner and assembled in tubular form close to the point of use.

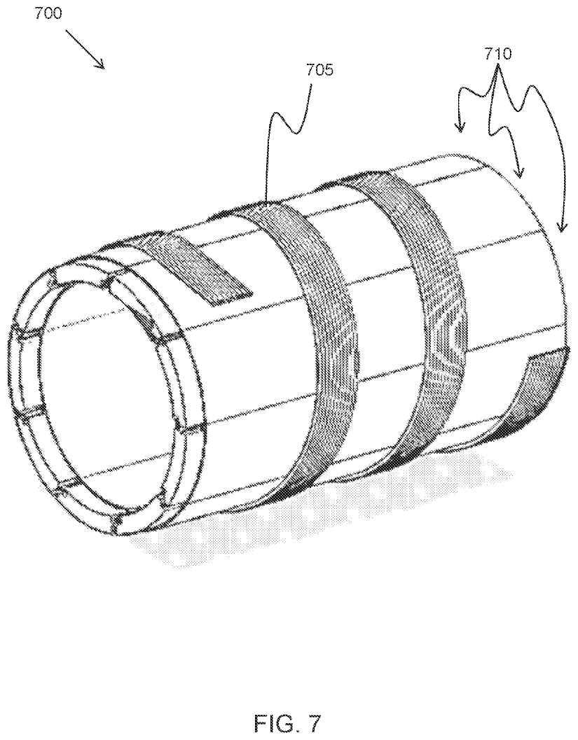

The first filament is not shown in FIG. 1 for the purposes of clarity; however, details regarding the filament wind are provided further below with reference to FIG. 7.

FIG. 2a shows an exploded view of a tube 200 according to an embodiment of the invention.

As with the tube 100 shown in FIG. 1, the tube 200 shown in FIG. 2 includes a plurality of tube perimeter sections 210 and each tube perimeter section comprises: an outer surface 220; an inner surface 230; a cavity disposed between the outer surface and the inner surface 240; and a side surface 250.

In this case, the side surface 250 of each tube perimeter section 210 comprises a projecting portion 260 and a recessed portion 270 as shown by the cross-sectional view in FIG. 2b. The recessed portion 270 is adapted to receive the projecting portion 260 of an adjacent side surface as shown in FIG. 2a. By way of example, the projecting portion and recessed portion may comprise a tongue and groove arrangement.

The tessellation of the projecting portions and recessed portions of the side surfaces may help to increase the strength of the adhesion between the side surfaces by providing three-dimensional bond lines required for strong adhesion. Further, the side surfaces may include a plurality of micro-ridges, thereby increasing the roughness of the contacting surfaces between tube perimeter sections. This may increase the bond strength between adjacent tube perimeter sections, and in particular when the tube perimeter sections are fastened to each other at least partially using an adhesive substance. The tube perimeter sections, and more specifically, the side surface of a tube perimeter section may include a sacrificial layer, such as a peel ply, which is adapted to be removed prior to fastening two adjacent tube perimeter sections. Such a sacrificial layer may be provided during the pultrusion process of manufacturing a tube perimeter section. When removed, the sacrificial layer will provide a clean and roughened surface on the side surface, thereby increasing the strength of the bond between two adjacent tube perimeter sections, particularly when fastened at least partially by way of an adhesive.

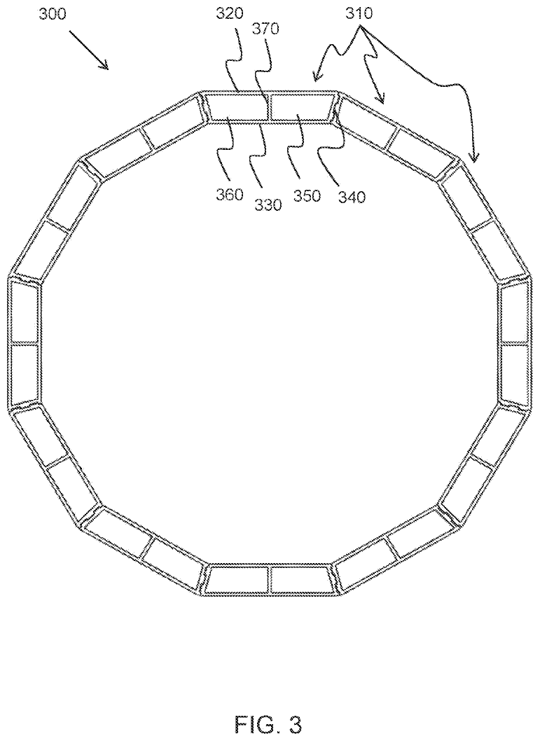

FIG. 3 shows a cross-sectional view of a tube 300 according to an embodiment of the invention.

As with the tube 100 shown in FIG. 1 and the tube 200 shown in FIG. 2, the tube 300 shown in FIG. 3 includes a plurality of tube perimeter sections 310, each tube perimeter section comprising: an outer surface 320; an inner surface 330; and a side surface 340. As can be seen from FIG. 3, the side surfaces 340 of the tube perimeter sections comprise a projecting portion and a recessed portion, the recessed portion being adapted to receive the projecting portion of an adjacent side surface.

In addition, the tube perimeter sections 310 comprise a first cavity 350 and a second cavity 360, separated by way of an interior wall 370. The first and second cavities may extend the entire length of the tube perimeter sections or the first and second cavities may extend through part of the tube perimeter sections. The internal wall 370 may extend along part of the length of the cavities or the entire length of the cavities.

The tube 300 shown in FIG. 3 demonstrates one of the plurality of different tube cross-sections that may be achieved using the plurality of tube perimeter sections in addition to the circular cross-section demonstrated in FIGS. 1 and 2.

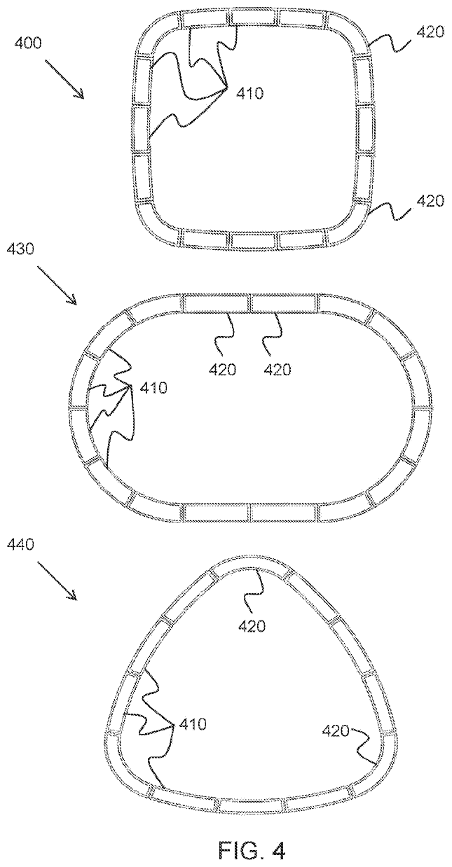

FIG. 4 demonstrates a plurality of possible tube cross-sections that may be achieved using the plurality of tube perimeter sections, which may include one or more of: a circular shape; an elliptical shape; a square shape; a rectangular shape; and a polygonal shape.

In particular, FIG. 4 shows a first tube cross-section 400 having a square shape wherein the tube cross section is formed by a combination of a plurality of tube perimeter sections 410 and a plurality of transition tube perimeter sections 420, the transition tube perimeter sections being adapted to be located between the side surfaces of adjacent tube perimeter sections. Each transition tube perimeter section may comprise a first surface adapted to be fastened to the side surface of a first tube perimeter section and a second surface adapted to be fastened to the side surface of a second tube perimeter section, thereby fastening the side surface of the first tube perimeter section to the side surface of the second tube perimeter section by way of the transition tube perimeter section.

Put another way, tube perimeter sections may be fastened to each other in an indirect manner using a transition tube perimeter section, the transition tube perimeter section having a different shape to the plurality of tube perimeter sections, in order to adjust the cross-section of the tube. Any number of transition tube perimeter section may be provided between adjacent tube perimeter sections.

In addition, FIG. 4 shows a second tube cross-section 430, having an elliptical shape, and a third tube cross-section 440, having a triangular shape, formed from a combination of tube perimeter sections 410 and transition tube perimeter sections 420.

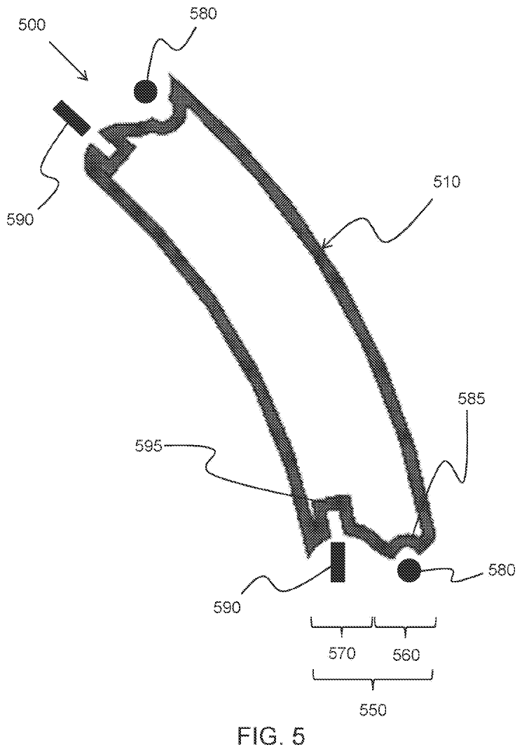

FIG. 5 shows a cross-sectional view 500 of a tube perimeter section 510 according to an embodiment of the invention.

In the example shown in FIG. 5, the side surface 550 of the tube perimeter section 510 comprises a protruding portion 560 and a recessed portion 570 as described above with reference to FIG. 2a.

In addition, in the example shown in FIG. 5, the tube includes a plurality of reinforcement rods 580 and the side surface 550 comprises a slot 585 adapted to receive a corresponding reinforcement rod. Alternate reinforcement rods 590 and an alternate slot 595 are shown to illustrate alternative shapes and sizes of rods that may be implemented across various designs of the tube.

Put another way, additional small cavities may be provided to enable the positioning of composite or steel reinforcement rods that may be provided to further improve the structural performance of the tube.

The reinforcement rods 580 may either be slid into the slots 585 along the length of the tube with resin pumped in from one end to the other. Alternately, dry fiberglass roving, or braided rope, may be pulled through the slots and resin then pumped in to consolidate the joint and form the reinforcement rod 580.

The reinforcement rod 580 may extend beyond an end of the tube perimeter section 510. In this way, the reinforcement rod may increase the strength of the tube across multiple stacked levels of tube perimeter sections.

In other words, where tube perimeter sections are stacked in a lengthwise manner, for example to increase the length of the tube, the reinforcement rod may extend across multiple tube perimeter sections in order to increase the strength of the tube.

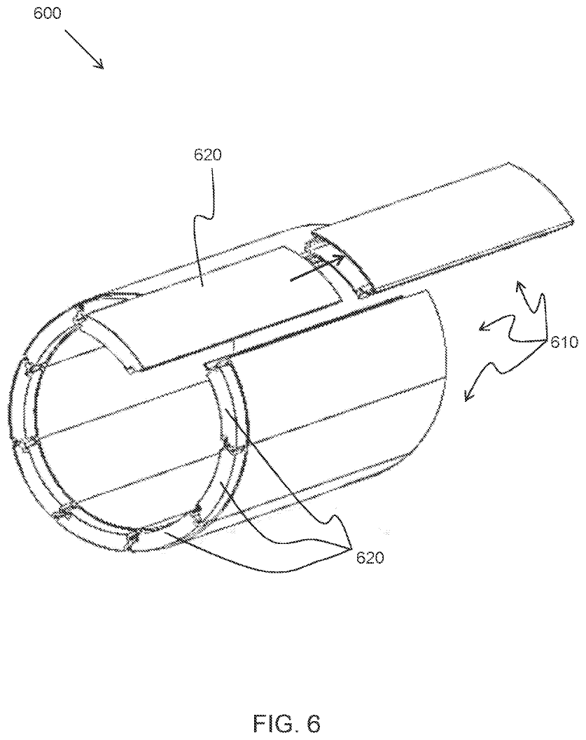

FIG. 6 shows an exploded view of a tube 600 according to an embodiment of the invention, wherein the tube perimeter sections each comprise a cavity.

In the example shown in FIG. 6, the cavity of each of the tube perimeter sections 610 is filled with a filler 620. In this way, the strength, and in some cases the stiffness, of the tube may be increased.

The nature of the bi-wall design of the tube perimeter sections will result in a tube that is more tolerant against local face buckling than traditional single wall designs. However, additional strength and stiffness may be provided by injecting a filler into the cavity. The filler may be either a cement or polymer-based material depending on the structural requirements of the tube. The material thickness of the tube perimeter sections for filler-based designs may be different to hollow designs. Further, the individual combination of wall thickness, wall material and filler material may be altered on an application specific basis.

In a similar manner to the reinforcement rods described above with reference to FIG. 5, the filler may extend beyond an end of the tube perimeter section such that a portion of the filler of one tube perimeter section may extend into another tube perimeter section, for example when arranged lengthways.

FIG. 7 shows a perspective view of a tube 700 according to an embodiment of the invention.

In the example shown in FIG. 7, the tube 700 further comprises a filament wind 705, for example the first filament, wherein the filament wind is wound about the plurality of tube perimeter sections 710. In this way, a high strength outer layer may be incorporated into the tube without the need for a separate spindle.

In other words, by providing a filament wind over the segmented pultruded sections, i.e. the tube perimeter sections 710, a high strength outer layer is formed that may help to overcome high shear forces encountered in bending of the tube when put under stress. The filament may be wound over the tube perimeter sections at an angle to the length of the tube. The filament winding may be performed within a range of angles from 5 degrees to 95 degrees, for example between 30 degrees and 90 degrees, depending on the material property requirements and geometrically related constructability factors associated with the filament winding process.

The filament wind 705 may be constructed from any suitable filament winding material. Further, the filament winding may be performed according to typical filament winding methods using the tube 700 in place of a spindle that would otherwise be required to receive the filament wind.

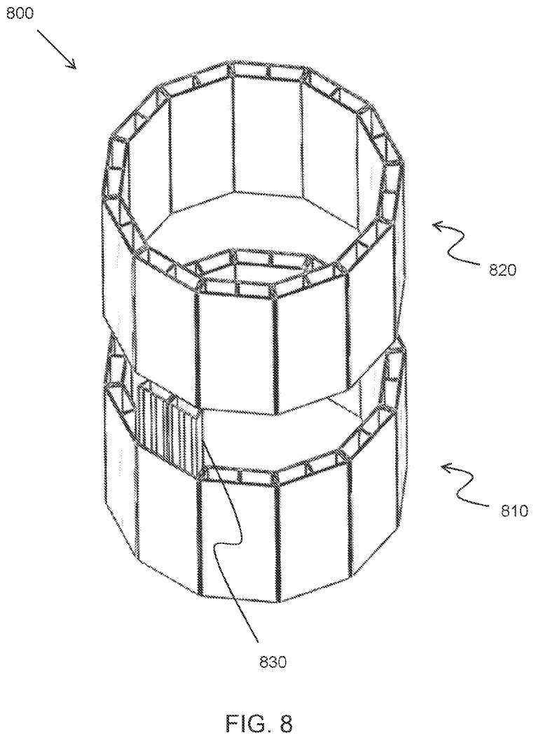

FIG. 8 shows an exploded view of a tube 800 according to an embodiment of the invention.

The tube 800 shown in FIG. 8 comprises a first plurality of tube perimeter sections 810 as described above and a second plurality of tube perimeter sections 820 stacked on the first plurality of tube perimeter sections. The second plurality of tube perimeter sections may be identical to the first plurality of tube perimeter sections or may differ in size and shape according to the application of the tube 800.

In this example, the first plurality of tube perimeter sections may have a first filament wound about the outer surfaces of the first plurality of tube perimeter sections and second the plurality of perimeter sections may have a second filament wound about the outer surfaces of the second plurality of tube perimeter sections. The first and second filaments may be separate filaments and may not extend from one plurality of tube perimeter sections to another, i.e. over the joint between the first and second pluralities of tube perimeter sections, thereby avoiding the complex constructional concerns relating to filament winding of large structures.

Any number of pluralities of tube perimeter sections may be stacked in order to form a tube of the desired length according to the application of the tube.

In addition, the tube 800 comprises an internal connector 830 adapted to be received by a cavity of a tube perimeter section, such that, when the second plurality of tube perimeter sections is stacked on the first plurality of tube perimeter sections, the internal connector is adapted to extend from a cavity of a tube perimeter section of the first plurality of tube perimeter sections to a cavity of a tube perimeter section of the second plurality of tube perimeter sections.

An internal connector 830 may be provided for any number of tube perimeter sections of the first, or second, plurality of tube perimeter sections. The internal connector may be an integral part of a tube perimeter section formed during the pultrusion process or a separate component.

In the examples described above, the cross-section of the tube has been shown as circular. However, the cross-section of the tube may take any shape appropriate to the implementation of the tube. For example, the cross-section of the tube, perpendicular to a tube elongate axis, may be any one or more of a circular shape; an elliptical shape; a square shape; a rectangular shape; and a polygonal shape. The cross-section may also be a combination of various shapes.

The tube described above may be any tubular construction. For example, the tube may be a conventional pipe or tube for carrying a fluid. Alternatively, the tube may be a utility pipe, for carrying utilities such a wiring, smaller piping or fibre optic cables.

Further, the tube may be a pole, such as a utility pole for carrying conductors. In a yet further example, the tube may be a tunnel wherein the hollow interior of the tube is large enough to permit the passage of vehicles.

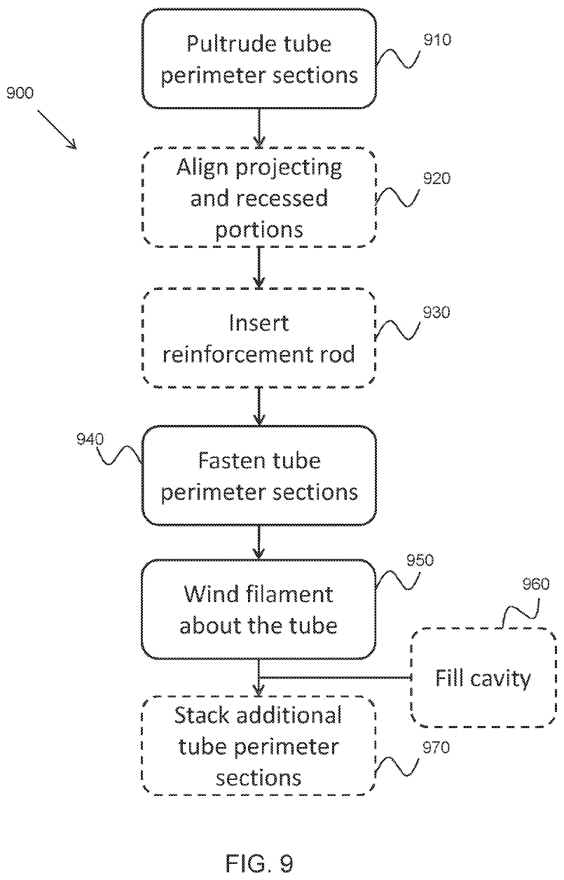

FIG. 9 shows a method 900 for manufacturing a tube as described above.

The method begins in step 910, wherein a first plurality of tube perimeter sections is pultruded, the first plurality of tube perimeter sections having the same pultrusion cross-sectional shape, each tube perimeter section comprising: an outer surface; an inner surface; a side surface, wherein the side surface is adapted to be fastened to an adjacent side surface of an adjacent tube perimeter section; and a cavity between the inner surface and the outer surface, wherein the cavity extends through the tube perimeter section.

In an embodiment where the side surface comprises a projecting portion and a recessed portion, the method may further comprise step 920 wherein the extending portion of a tube perimeter portion is aligned with the recessed portion of an adjacent tube perimeter portion.

Alternatively, the tube may comprise one or more transition tube perimeter sections adapted to be located between the side surfaces of adjacent tube perimeter sections, and each comprising: a first surface adapted to be fastened to the side surface of a first tube perimeter section; and a second surface adapted to be fastened to the side surface of a second tube perimeter section. In this case, the method may comprise the step if fastening the first surface to the side surface of a first tube perimeter section and fastening the second surface to the side surface of a second perimeter section, thereby fastening the side surface of the first tube perimeter section to the side surface of the second tube perimeter section by way of the one or more transition tube perimeter sections.

The transition tube perimeter sections may be formed in any shape, and of any material, according to the desired application of the tube.

In an embodiment where the side surface of each tube perimeter section comprises a slot adapted to receive a reinforcement rod, the method may further comprise step 930 wherein the reinforcement rod is inserted into the slot.

In step 940, the first plurality of tube perimeter sections are fastened to each other by way of the side surfaces, thereby forming a cross-section of the tube. The first plurality of tube perimeter sections may be fastened to each other by any suitable fastening means.

In step 950, a first filament is wound about the first plurality of tube perimeter sections as described above.

In step 960, if the tube perimeter sections comprise a cavity, the cavity of each tube perimeter section may be filled with a filler.

Following any or all of steps 940 to 960, or both, in step 970 a second plurality of tube perimeter sections may be stacked on the first plurality of tube perimeter sections, wherein the first plurality of tube perimeter sections may be connected to the second plurality of tube perimeter sections by way of an internal connector, the reinforcement rod and/or the filling of the cavity.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. If a computer program is discussed above, it may be stored/distributed on a suitable medium, such as an optical storage medium or a solid-state medium supplied together with or as part of other hardware, but may also be distributed in other forms, such as via the Internet or other wired or wireless telecommunication systems. If the term “adapted to” is used in the claims or description, it is noted the term “adapted to” is intended to be equivalent to the term “configured to”. Any reference signs in the claims should not be construed as limiting the scope.

1. A tube for use as a part of a structural support pole comprising:
a first plurality of tube perimeter sections, wherein each tube perimeter section of the first plurality of tube perimeter sections is formed by pultrusion, each tube perimeter section of the first plurality of tube perimeter sections having the same pultrusion cross-sectional shape, and wherein each tube perimeter section comprises:
an outer surface;
an inner surface;
a side surface, wherein the side surface is adapted to be fastened to an adjacent side surface of an adjacent tube perimeter section, thereby to form an annular arrangement of tube perimeter sections; and
a cavity between the inner surface and the outer surface, wherein the cavity extends through the tube perimeter section; and
a first filament, wherein the first filament is wound about the outer surfaces of the first plurality of tube perimeter sections arranged in an annular arrangement.

2. A tube as claimed in claim 1, wherein the side surface of each tube perimeter section comprises:
a projecting portion; and
a recessed portion, wherein the recessed portion is adapted to receive the projecting portion of an adjacent side surface.

3. A tube as claimed in claim 1, wherein the tube further comprises one or more transition tube perimeter sections, wherein the one or more transition tube perimeter sections are adapted to be located between the side surfaces of adjacent tube perimeter sections, and wherein each transition tube perimeter section comprises:
a first surface adapted to be fastened to the side surface of a first tube perimeter section; and
a second surface adapted to be fastened to the side surface of a second tube perimeter section, thereby fastening the side surface of the first tube perimeter section to the side surface of the second tube perimeter section by way of the one or more transition tube perimeter sections.

4. A tube as claimed in claim 1, wherein the tube comprises a filler, and wherein the cavity of each perimeter tube section is adapted to receive the filler, the filler comprising one or more of:
a cement;
a polymer-based foam; and
a polymer-based rigid filler.

5. A tube as claimed in claim 1, wherein each tube perimeter section comprises a percentage of uni-directional fibres greater than or equal to 30%, for example, greater than or equal to 40%, for example, greater than or equal to 50%.

6. A tube as claimed in claim 1, wherein the first filament is wound about the first plurality of tube perimeter sections at a wind angle, wherein the wind angle is defined between a longitudinal axis, which is defined as the central axis of the annular arrangement of tube perimeter sections, and a filament elongate axis, and wherein the wind angle is between 30° and 90°.

7. A tube as claimed in claim 1, wherein the cross-section of the tube, perpendicular to a tube elongate axis, is one or more of:
a circular shape;
an elliptical shape;
a square shape;
a rectangular shape; and
a polygonal shape.

8. A tube as claimed in claim 1, wherein the tube further comprises:
a second plurality of tube perimeter sections, wherein each tube perimeter section of the second plurality of tube perimeter sections is formed by pultrusion, each tube perimeter section of the second plurality of tube perimeter sections having the same pultrusion cross-sectional shape, and wherein each tube perimeter section comprises:
an outer surface;
an inner surface;
a side surface, wherein the side surface is adapted to be fastened to an adjacent side surface of an adjacent tube perimeter section, thereby to form an annular arrangement of tube perimeter sections; and
a cavity between the inner surface and the outer surface, wherein the cavity extends through the tube perimeter section;
a second filament, wherein the second filament is wound about the outer surfaces of the second plurality of tube perimeter sections arranged in an annular arrangement; and
wherein the second plurality of tube perimeter sections is adapted to be stacked on the first plurality of tube perimeter sections.

9. A tube as claimed in claim 8, further comprising an internal connector adapted to be received by a cavity of a tube perimeter section, and wherein, when the second plurality of tube perimeter sections is stacked on the first plurality of tube perimeter sections, the internal connector is adapted to extend from a cavity of a tube perimeter section of the first plurality of tube perimeter sections to a cavity of a tube perimeter section of the second plurality of tube perimeter sections.

10. A tube as claimed in claim 1, wherein the tube comprises a plurality of reinforcement rods and wherein the side surface of each tube perimeter section comprises a slot adapted to receive a reinforcement rod.

11. A method for manufacturing a tube for use as a part of a structural support pole, the method comprising:
pultruding a first plurality of tube perimeter sections, the first plurality of tube perimeter sections having the same pultrusion cross-sectional shape, wherein each tube perimeter section of the first plurality of tube perimeter sections comprises:
an outer surface;
an inner surface;
a side surface, wherein the side surface is adapted to be fastened to an adjacent side surface of an adjacent tube perimeter section; and
a cavity between the inner surface and the outer surface, wherein the cavity extends through the tube perimeter section;
fastening the first plurality of tube perimeter sections to each other by way of the side surfaces, thereby forming a first cross-section of the tube; and
winding a first filament about the outer surfaces of the first plurality of tube perimeter sections.

12. A method as claimed in claim 11, wherein:
the side surface of the perimeter sections comprises:
a projecting portion; and
a recessed portion, wherein the recessed portion is adapted to receive the projecting portion of an adjacent side surface;
and wherein the method further comprises aligning the extending portion of a tube perimeter portion with the recessed portion of an adjacent tube perimeter portion; or
the tube further comprises one or more transition tube perimeter sections adapted to be located between the side surfaces of adjacent tube perimeter sections, and wherein each transition tube perimeter sections comprises:
a first surface adapted to be fastened to the side surface of a first tube perimeter section; and
a second surface adapted to be fastened to the side surface of a second tube perimeter section;
and wherein the method further comprises fastening the first surface to the side surface of a first tube perimeter section and fastening the second surface to the side surface of a second perimeter section, thereby fastening the side surface of the first tube perimeter section to the side surface of the second tube perimeter section by way of the one or more transition tube perimeter sections.

13. A method as claimed in claim 11, wherein the side surface of each tube perimeter section comprises a slot adapted to receive a reinforcement rod, and wherein the method further comprises inserting the reinforcement rod into the slot.

14. A method as claimed in claim 11, wherein the method further comprises filing the cavity.

15. A method as claimed in claim 11, wherein the method further comprises:
pultruding a second plurality of tube perimeter sections, the second plurality of tube perimeter sections having the same pultrusion cross-sectional shape, wherein each tube perimeter section of the second plurality of tube perimeter sections comprises:
an outer surface;
an inner surface;
a side surface, wherein the side surface is adapted to be fastened to an adjacent side surface of an adjacent tube perimeter section; and
a cavity between the inner surface and the outer surface, wherein the cavity extends through the tube perimeter section;
fastening the second plurality of tube perimeter sections to each other by way of the side surfaces, thereby forming a second cross-section of the tube;
winding a second filament about the outer surfaces of the first plurality of tube perimeter sections; and
stacking the second plurality of tube perimeter sections on the first plurality of tube perimeter sections.

16. A method as claimed in claim 15, wherein the method further comprises providing an internal connector to the cavity of each of the tube perimeter sections, wherein the internal connector is adapted to extend from a cavity of a tube perimeter section of the first plurality of tube perimeter sections to a cavity of a tube perimeter section of the second plurality of tube perimeter sections when the second plurality of tube perimeter sections is stacked on the first plurality of tube perimeter sections.
